(19) United States
(12) Patent Application Publication
(10) Pub. No.: US 2026/0153779 A1
(43) Pub. Date: Jun. 4, 2026

(54) ENTANGLED PHOTON PUMP REJECTION FILTER

(71) Applicant: VIAVI Solutions Inc., Chandler, AZ (US)

(72) Inventor: Georg J. OCKENFUSS, Santa Rosa, CA (US)

(21) Appl. No.: 19/258,393

(22) Filed: Jul. 2, 2025

Related U.S. Application Data
(60) Provisional application No. 63/727,426, filed on Dec. 3, 2024.

(51) Int. Cl. G02F 1/35; G02B 5/28; G02F 1/39

(52) U.S. Cl. CPC G02F 1/3503; G02F 1/39; G02B 5/285

(57) ABSTRACT

In some implementations, an optical filter includes a set of filter layers, wherein the set of filter layers includes alternating layers of a first material and a second material, the first material having a refractive index greater than the second material, and wherein the set of filter layers is associated with a first transmissivity of less than a first threshold at a first wavelength of a pump signal and is associated with a second transmissivity of greater than a second threshold at a second wavelength of a set of signal photons generated from the pump signal, wherein the second wavelength is twice the first wavelength.

### CROSS-REFERENCE TO RELATED APPLICATION

This patent application claims priority to U.S. Provisional Patent Application No. 63/727,426, filed on Dec. 3, 2024, and entitled “ENTANGLED PHOTON PUMP REJECTION FILTER IN THE NEAR-INFRARED SPECTRUM.” The disclosure of the prior application is considered part of and is incorporated by reference into this patent application.

### BACKGROUND

Spontaneous parametric down-conversion (SPDC) is a nonlinear optical process in which a high-energy photon interacts with a nonlinear crystal and splits into two lower-energy photons, known as signal and idler photons. The nonlinear crystal may have a property of birefringence, which enables phase matching by compensating for differences in refractive indices of interacting waves. The generated photon pairs exhibit quantum correlations, often manifesting as entanglement in polarization, momentum, or time-energy degrees of freedom. SPDC may have use in quantum optics, such as for quantum cryptography, quantum computing, quantum key distribution, quantum sensing, or quantum communication, among other examples.

### SUMMARY

In some implementations, an optical filter includes a set of filter layers, wherein the set of filter layers includes alternating layers of a first material and a second material, the first material having a refractive index greater than the second material, and wherein the set of filter layers is associated with a first transmissivity of less than a first threshold at a first wavelength of a pump signal and is associated with a second transmissivity of greater than a second threshold at a second wavelength of a set of signal photons generated from the pump signal, wherein the second wavelength is twice the first wavelength, and wherein absorption of the first wavelength occurs at the set of filter layers or a substrate onto which the set of filter layers are disposed.

In some implementations, an optical filter includes a substrate to block a first wavelength with at least a threshold blocking level, wherein the substrate is transparent at a second wavelength that is twice the first wavelength; and a set of anti-reflectance coatings, for the second wavelength, disposed on the substrate, wherein the optical filter is configured to pass through the second wavelength with at least a threshold transmissivity level.

In some implementations, an optical system includes a laser configured to output a beam associated with a first wavelength; a set of optics configured to convert the beam associated with the first wavelength into a set of entangled signal photons associated with a second wavelength, wherein the second wavelength is twice the first wavelength; and a rejection filter configured to pass through the set of entangled signal photons associated with the second wavelength and block a residual pump portion of the beam associated with the first wavelength.

### BRIEF DESCRIPTION OF THE DRAWINGS

FIG. 1 is a diagram of an example implementation associated with an optical system including an entangled photon pump rejection filter.

FIGS. 2A-2B are diagrams of an example associated with a layer structure of an optical filter.

FIGS. 3A-3C are diagrams of an example associated with optical characteristics of an optical filter.

### DETAILED DESCRIPTION

The following detailed description of example implementations refers to the accompanying drawings. The same reference numbers in different drawings may identify the same or similar elements.

An optical element, such as a nonlinear crystal, can be used to produce pairs of photons from a photon beam. For example, an optical emitter may emit a pump input photon that is directed toward the optical element, which may produce a pair of quantum-entangled output photons from the input photon. The pair of output photons may be referred to as a signal photon and an idler photon. In accordance with the laws of conservation of energy and conservation of momentum, the pair of output photons have a combined energy and momenta equal to the original input photon. By generating two output photons from a single input photon, when the input photon is associated with a first wavelength and a first frequency, the two output photons have a second wavelength that is half the first wavelength (and a second frequency that is twice the first frequency). An optical system may use the output photons for one or more quantum-entanglement-related use cases, such as for quantum cryptography, quantum computing, quantum sensing, or quantum communications. Additionally, or alternatively, the optical system may use the output photons, with the second wavelength, for one or more non-quantum-entanglement-related use cases, such as for conventional sensing at a different wavelength than the first wavelength that is achieved by the optical emitter.

A conversion efficiency of a nonlinear crystal performing spontaneous parametric down-conversion (SPDC) to generate two output photons from a single input photon may be on an order of approximately 1×10⁻⁶. Accordingly, many photons of a first wavelength of the optical emitter may remain when generating pairs of photons of a second wavelength (e.g., that is twice the first wavelength). Some optical receivers may detect each received photon without regard to a wavelength. Accordingly, when photons of the first wavelength remain in an optical path as a result of conversion inefficiency, an optical receiver may register both pump photons (e.g., the unconverted input photons) and photon pair photons (e.g., the signal photon or idler photon). Accordingly, measurement inaccuracies may occur when attempting to measure only the photon pair photons (e.g., with the second wavelength).

Some implementations described herein enable wavelength filtering for entangled photon generation. For example, an entangled photon pump rejection filter may be configured to have a high level of blocking for photons with a first, pump wavelength and a high level of transmissivity for photons with a second, signal/idler wavelength. In some implementations, an optical filter, such as an entangled photon pump rejection filter, may be configured to have at least a threshold optical density (OD) rejection level, such as at least an OD 10 rejection level, which may correspond to a transmission percentage of less than 0.00000001% transmission at a blocking wavelength (e.g., the wavelength of the pump photons), which may result in a ratio of signal photons to residual pump photons of at least 1×10⁻¹:1 and a false count rate of less than 85.95%. In some implementations, the optical filter may have a rejection level of OD 11, OD 12, OD 13, or higher, which may result in false count rates of less than 37.95%, 5.76%, or 0.61%, respectively. In some implementations, the optical filter may achieve rejection levels of OD 10 or higher without using quarterwave stacks or thick dielectric coatings. For example, the optical filter may achieve the rejection levels using an amorphous silicon coating to absorb pump photons and pass signal photons. In this way, the optical filter can achieve high rejection levels for pump photons with a relatively thin coating, thereby reducing a likelihood of manufacturing defects. Additionally, or alternatively, the optical filter may use amorphous silicon or other materials described herein to achieve a low level of reflectance at the idler and signal wavelengths and a high level of rejection of the pump laser.

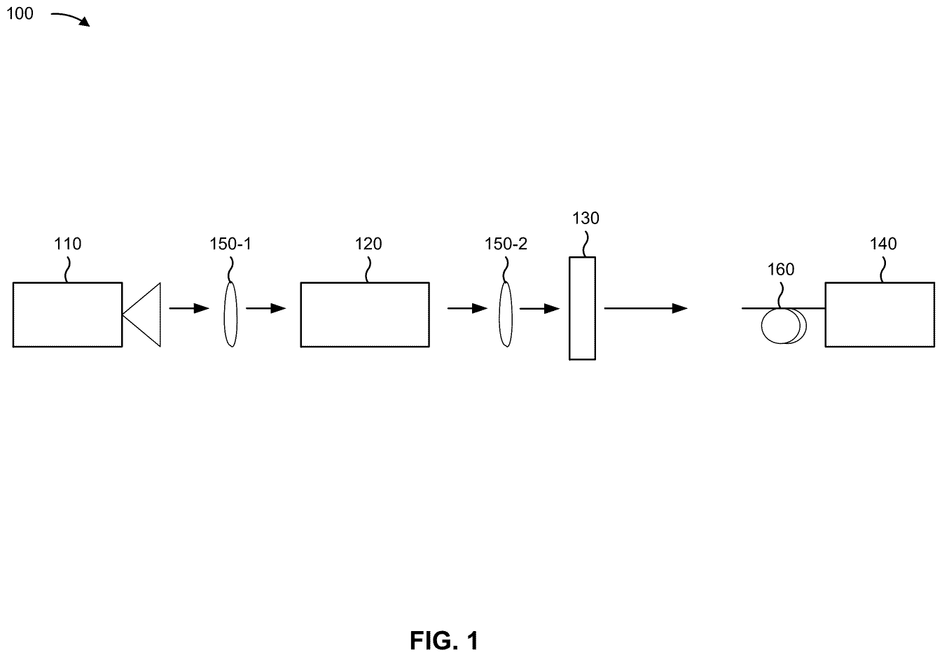

FIG. 1 is a diagram of an example implementation associated with an optical system including an entangled photon pump rejection filter. As shown in FIG. 1, example optical system 100 includes an optical emitter 110, a non-linear optic 120, an optical filter 130, and an optical receiver 140. Additionally, or alternatively, the optical system 100 may include a set of optics 150, such as a first optic 150-1 and a second optic 150-2, and an optical fiber 160.

The optical emitter 110 may include an optical device associated with generating a beam. For example, the optical emitter 110 may include a laser emitter associated with outputting photons with a configured pump wavelength and at a particular output rate. As one example, the optical emitter 110 may be a 405 nanometer (nm) laser emitter that outputs photons (e.g., with a pump wavelength of 405 nm) at a rate of 10¹⁶ photons per second (photon/second). In some implementations, the optical emitter 110 may output a beam with a pump wavelength of 775 nm. In some implementations, the optical emitter 110 may output a beam with photons at a set of wavelengths. For example, the optical emitter 110 may output a beam with photons at multiple different wavelengths, which the first optic 150-1 may filter such that only a single wavelength is provided toward the non-linear optic 120. Additionally, or alternatively, the optical emitter 110 may output a beam at an initial wavelength, which the first optic 150-1 may convert into a target wavelength for SPDC (e.g., via shifting or another optical filtering technique). In some implementations, the optical emitter 110 may include a particular type of laser, such as a semiconductor diode laser, a single longitudinal mode (SLM) laser, a multi-mode laser, a diode-pumped solid-state laser, a metal vapor laser, or another type of laser.

The non-linear optic 120 may include a type of optic associated with achieving SPDC to convert a beam received at a pump wavelength into a set of signal and idler photons at a signal/idler wavelength. For example, the non-linear optic 120 may include a non-linear crystal that receives a set of photons at a first wavelength and outputs a set of photon pairs at a second wavelength. The second wavelength may be related to the first wavelength in accordance with SPDC. For example, the second wavelength may be twice the first wavelength, such as the non-linear optic 120 converting a 405 nm pump photon into a pair of 810 nm signal/idler photons or converting a 775 nm pump photon into a pair of 1550 nm signal/idler photons. In accordance with the law of conservation of energy, the non-linear optic 120 may conserve energy when achieving SPDC, such that a 405 nm photon beam with an energy of 4.9×10⁻¹⁹ Joules (J) per photon (J/photon) is converted into a pair of 810 nm photons with a total energy of 4.9×10⁻¹⁹ J/photon. When transmitted with a power of 30 milliwatts (mW), the non-linear optic 120 may convert pump photons with a photon flux of 6.1×10¹⁶ photon/second into signal/idler photons with a photon flux of 1.0×10⁶ photons/second. Similarly, a 775 nm photon beam with an energy of 2.6×10⁻¹⁹ J/photon is converted into a pair of 1550 nm photons with a total energy of 2.6×10⁻¹⁹ J/photon and the photon flux is converted from 1.2×10¹⁷ photon/second for the 775 pump photon beam into signal/idler photon beam with a photon flux of 1.0×10⁶ photons/second.

The optical filter 130 may include a rejection filter associated with blocking a beam with a first wavelength and passing through a beam with a second wavelength. For example, the optical filter 130 may be configured to block residual pump photons and pass through signal/idler photons. As an example, at a wavelength of 405 nm, the optical filter 130 blocks the first wavelength. In contrast, at a wavelength of 775 nm, a substrate (e.g., which may be a layer of the optical filter 130 or a substrate onto which the optical filter 130 is disposed) may block the first wavelength.

Accordingly, the optical filter 130 (and a substrate thereof of or a substrate onto which the optical filter 130 is disposed) may be configured as a blocking filter at a first wavelength and a transmissive optic at a second wavelength that is twice the first wavelength, such as blocking 405 nm photons and passing through 810 nm photons or blocking 775 nm photons and passing through 1550 nm photons. In some implementations, the optical filter 130 may achieve a particular level of blocking. For example, the optical filter 130 may achieve an OD 10 or higher level of blocking, which may correspond to a transmissivity level 1×10⁻¹⁰ (1×10⁻⁸% transmissivity). For 405 nm pump photons and 810 nm signal/idler photons, an OD 10 level of blocking may correspond to a ratio of signal photons to residual photons of 1.6×10⁻¹:1 and a false count rate of 85.95%, as illustrated in Table 1:

| | | Ratio of Signal | |
|---|---|---|---|
| | | Photons to Residual | False |
| OD Level | Transmission (%) | Photons | Count (%) |
| 1 | 1 × 10¹ | 1.6 × 10⁻¹⁰:1 | 100.00 |
| 2 | 1 × 10⁰ | 1.6 × 10⁻⁹:1 | 100.00 |
| 3 | 1 × 10⁻¹ | 1.6 × 10⁻⁸:1 | 100.00 |
| 4 | 1 × 10⁻² | 1.6 × 10⁻⁷:1 | 100.00 |
| 5 | 1 × 10⁻³ | 1.6 × 10⁻⁶:1 | 100.00 |
| 6 | 1 × 10⁻⁴ | 1.6 × 10⁻⁵:1 | 100.00 |
| 7 | 1 × 10⁻⁵ | 1.6 × 10⁻⁴:1 | 99.98 |
| 8 | 1 × 10⁻⁶ | 1.6 × 10⁻³:1 | 99.84 |
| 9 | 1 × 10⁻⁷ | 1.6 × 10⁻²:1 | 98.39 |
| 10 | 1 × 10⁻⁸ | 1.6 × 10⁻¹:1 | 85.95 |
| 11 | 1 × 10⁻⁹ | 1.6 × 10⁰:1 | 37.95 |
| 12 | 1 × 10⁻¹⁰ | 1.6 × 10¹:1 | 5.76 |
| 13 | 1 × 10⁻¹¹ | 1.6 × 10²:1 | 0.61 |

In some implementations, the optical filter 130 may include a particular structure that achieves a high level of blocking at the first wavelength and a high level of transmissivity at the second wavelength. For example, for a pump signal at 405 nm (or another wavelength in a similar range), the optical filter 130 may include an alternating layer structure of amorphous silicon (e.g., which may have a refractive index of greater than 3.0) and another material (e.g., a low-refractive index material, which may have a refractive index of less than 3.0, such as silicon dioxide). Additionally, or alternatively, for a pump signal at 775 nm (or another wavelength in a similar range), the optical filter 130 may include a silicon wafer with an anti-reflectance (AR) coating (e.g., an AR coating for 1550 nm or 775 nm or both). Additionally, or alternatively, the optical filter 130 may include another type of layer, such as an organic filter layer. In some implementations, the optical filter 130 may achieve a dispersion of less than a threshold amount.

The optical receiver 140 may include a photon detector. For example, the optical receiver 140 may be configured to determine a count of photons incident on a detector of the optical receiver 140. Accordingly, blocking residual photons with a pump wavelength prevents false counts from affecting a measurement by the optical receiver 140. In some implementations, the optical receiver 140 is connected to a transmission portion of the optical system 100 (e.g., the optical emitter 110, the non-linear optic 120, the optical filter 130, and one or more optics 150) via an optical fiber 160, such as a waveguide. The optical fiber 160 may direct photons to a detector of the optical receiver 140. In some implementations, the optical receiver 140 may be associated with one or more optics 150, such as one or more filters, lenses, gratings, or other optical elements.

As indicated above, FIG. 1 is provided as an example. Other examples may differ from what is described with regard to FIG. 1.

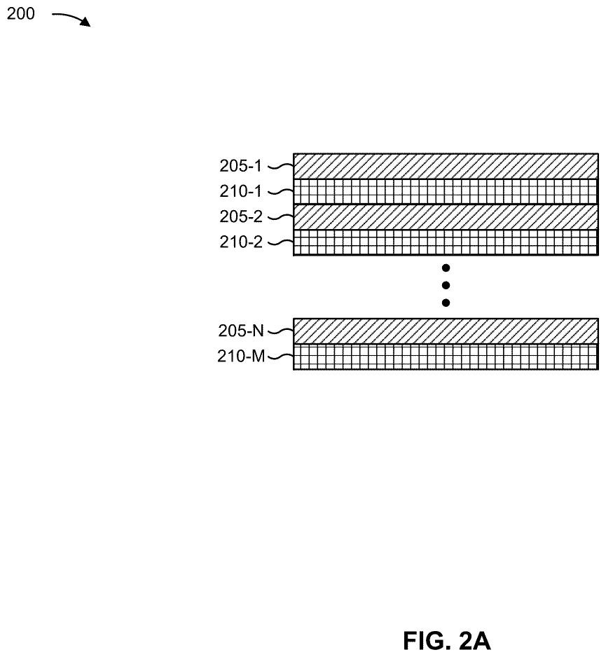

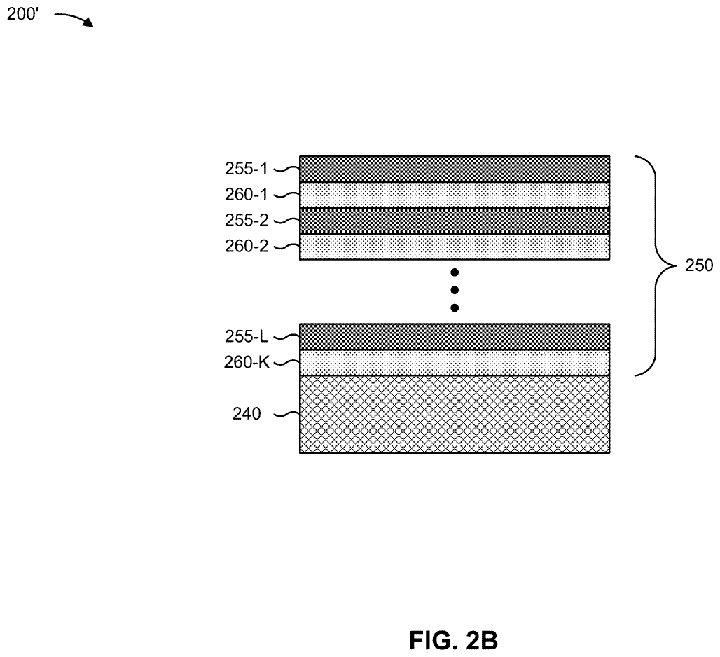

FIGS. 2A-2B are diagrams of examples associated with a layer structure of an optical filter.

As shown in FIG. 2A, an optical filter 200 includes a first set of layers 205-1 through 205-N and a second set of layers 210-2 through 210-M. For example, the optical filter 200 may include alternating high refractive index material layers (e.g., layers with a refractive index greater than or equal to a threshold) and low refractive index material layers (e.g., layers with a refractive index less than the threshold). In some implementations, one or more characteristics of the set of layers 205 and 210 may be configured in connection with a wavelength of a residual pump beam that is to be blocked by the optical filter 200 and a signal/idler beam that is to be passed through by the optical filter 200. For example, alternating layers of amorphous silicon (a:Si) and silicon dioxide (SiO₂) may be selected for rejecting 405 nm photons and passing through 810 nm photons. In this case, amorphous silicon is highly absorbing at the 405 nm wavelength (e.g., with an extinction coefficient, k, of 1.7 to 2.0) and is transparent at 810 nm (e.g., with an extinction coefficient, k, of less than or equal to 0.001). In some implementations, the optical filter 200 may be associated with less than a threshold thickness. For example, rather than including relatively thick quarterwave stacks, the optical filter 200 may include a set of layers with a thickness of approximately 338 nm (e.g., with an anti-reflectance (AR) coating applied on both sides) for a 405 nm/810 nm wavelength filter. In some implementations, the optical filter 200 may have a thickness of greater than approximately 250 nm or greater than approximately 300 nm for a 405 nm/810 nm wavelength filter.

In some implementations, for a 775 nm/1550 nm wavelength filter, a silicon substrate may be at least 0.2 millimeters (mm) thick. As an example, a 405 nm/810 nm wavelength filter may have a substrate and alternating layers of Si:H and SiO₂ according to the following layer count:

| Layer Number | Material | Thickness (nm) |
|---|---|---|
| 0 - Substrate | Silicon | |
| 1 | Si:H | 14.335 |
| 2 | SiO₂ | 46.751 |
| 3 | Si:H | 130.000 |
| 4 | SiO₂ | 17.105 |
| 5 | Si:H | 20.267 |
| 6 | SiO₂ | 47.337 |
| 7 | Si:H | 4.605 |
| 8 | SiO₂ | 92.715 |
| Air Interface | | |

In another example, a 775 nm/1550 nm wavelength filter may have a substrate and alternating layers of silicon dioxide and tantalum oxide, according to the following layer table:

| Layer Number | Material | Thickness (nm) |
|---|---|---|
| 0 - Substrate | Silicon | |
| 1 | SiO₂ | 35 |
| 2 | Ta₂O₅ | 100.5361 |
| 3 | SiO₂ | 1 |

As further shown in FIG. 2B, an optical filter 200′ includes a substrate 240. For example, the optical filter 200′ may include a monolithic substrate 240 selected from a material that rejects residual photons at a first wavelength (e.g., 775 nm) and passes through photons at a second wavelength (e.g., 1550 nm). In this example, a silicon wafer may serve as a silicon substrate 240 for a 775 nm residual wavelength and a 1550 nm signal/idler wavelength. In some implementations, one or more AR coatings 250 may be disposed on the substrate 240. The AR coatings 250 may include alternating layers 255 and 260 of high refractive index material and low refractive index material. For example, the optical filter 200′ may include a first AR coating 250 associated with being anti-reflective at the signal/idler wavelength or a second AR coating 250 associated with being anti-reflective at the residual wavelength. The presence of the AR coatings improve transmittance at a wavelength of interest. For example, the 1550 nm signal/idler wavelength transmittance is improved from 53% to greater than 90%, for example, by the presence of one or more AR coatings. In some implementations, the optical filter 200′ may include a single-layer AR coating aligned to one or more wavelengths. Additionally, or alternatively, the optical filter 200′ may include one or more multi-layer AR coatings.

As indicated above, FIGS. 2A-2B are provided as an example. Other examples may differ from what is described with regard to FIGS. 2A-2B.

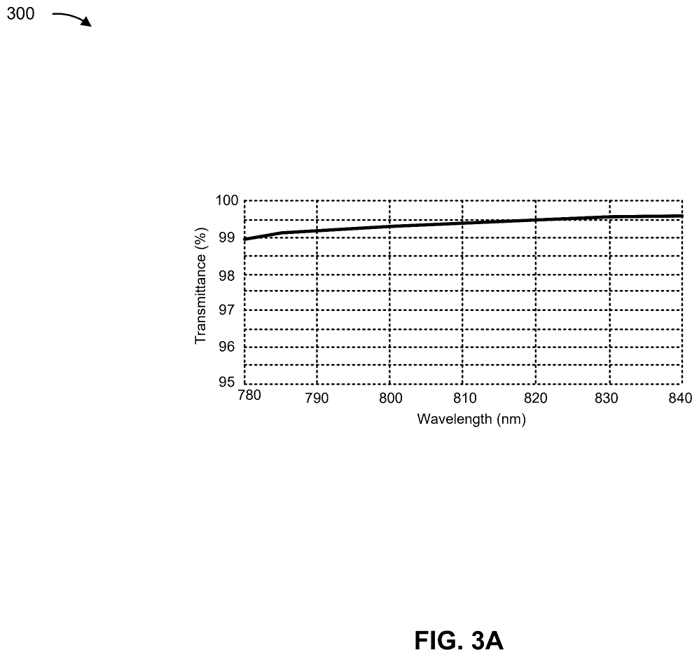

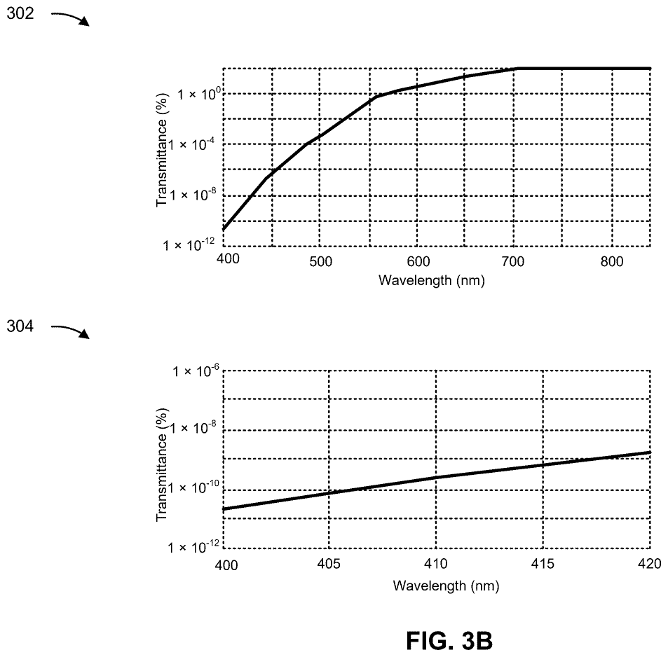

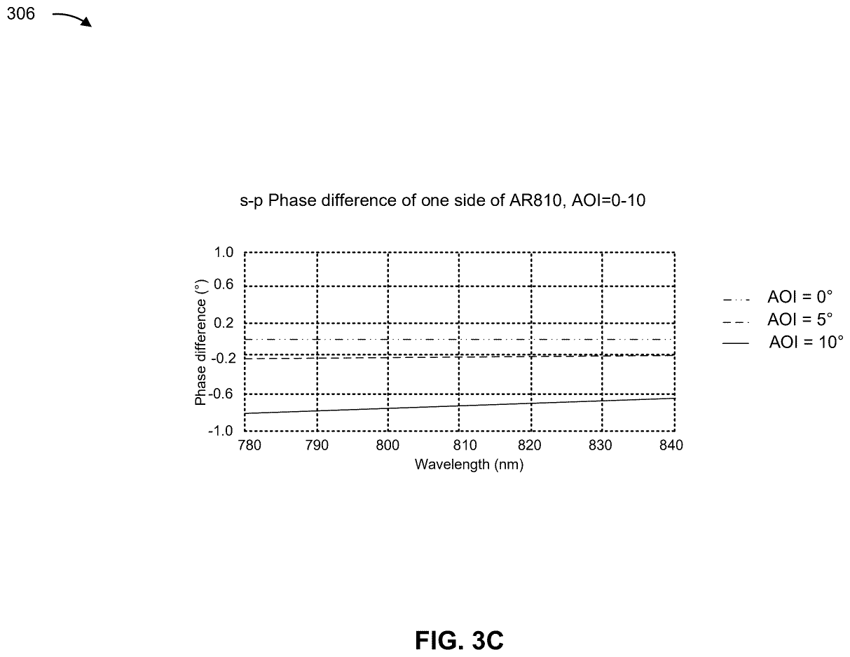

FIGS. 3A-3C are diagrams of an example 300 associated with optical characteristics of an optical filter.

As shown in FIG. 3A, and by diagram 300, an optical filter may include a double-sided AR coating for 810 nm disposed on a 0.5 millimeter (mm) thickness set of blocking layers matched to air and illuminated with collimated, unpolarized light at a range of angles of incidence (AOIs) from 0° to 10°. As shown, at a signal/idler wavelength of 810 nm+/−30 nm, for which the AR coating is configured, the optical filter exhibits a transmittance of between 99% and 100% at the range of the AOIs. Similarly, as shown in FIG. 3B, and by diagrams 302 and 304, the optical filter exhibits a transmittance of between approximately 1×10⁻¹¹ and 1×10⁻⁹ at a residual pump wavelength of 405 nm+/−5 nm across the range of AOIs. In other words, the optical filter exhibits a high degree of transmissivity for the signal/idler wavelength and an OD 11.7 level of blocking for the residual pump wavelength. FIG. 3C and diagram 306 shows a phase difference at one side of the AR coating for 810 nm of the optical filter. As shown, the AR coating exhibits a phase difference of between 0 degrees (°) and −0.8° across the range of AOIs, thereby exhibiting a relatively small phase shift, ensuring the optical filter does not negatively impact receiver performance as a result of angle-related phase shifting.

As indicated above, FIGS. 3A-3C are provided as an example. Other examples may differ from what is described with regard to FIGS. 3A-3C.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical filter, comprising:
a set of filter layers,
wherein the set of filter layers includes alternating layers of a first material and a second material,
the first material having a refractive index greater than the second material, and
wherein the set of filter layers is associated with a first transmissivity of less than a first threshold at a first wavelength of a pump signal and is associated with a second transmissivity of greater than a second threshold at a second wavelength of a set of signal photons generated from the pump signal, wherein the second wavelength is twice the first wavelength,
wherein absorption of the first wavelength occurs at the set of filter layers or a substrate onto which the set of filter layers are disposed.

2. The optical filter of claim 1, wherein a thickness of the set of filter layers is less than a threshold thickness.

3. The optical filter of claim 1, wherein the first transmissivity is less than a level of transmissivity corresponding to an optical density (OD) 10 at a pump laser generating the pump signal.

4. The optical filter of claim 1, wherein the first material is amorphous silicon.

5. The optical filter of claim 1, wherein the second material is silicon dioxide.

6. The optical filter of claim 1, wherein the first wavelength is approximately 405 nanometers, and wherein the set of filter layers is configured to absorb the first wavelength.

7. The optical filter of claim 1, wherein the first wavelength is approximately 775 nm, and wherein the substrate is configured to absorb the first wavelength.

8. The optical filter of claim 1, wherein the set of filter layers includes an organic filter layer.

9. An optical filter, comprising:
a substrate to block a first wavelength with at least a threshold blocking level,
wherein the substrate is configured to pass through a second wavelength that is twice the first wavelength with at least a threshold transmissivity level; and
a set of anti-reflectance coatings, for the second wavelength, disposed on the substrate.

10. The optical filter of claim 9, wherein the first wavelength is approximately 775 nanometers and the second wavelength is approximately 1550 nanometers.

11. The optical filter of claim 9, wherein the substrate is a silicon substrate.

12. The optical filter of claim 9, wherein the set of anti-reflectance coatings includes a single-layer anti-reflectance coating aligned to the second wavelength.

13. The optical filter of claim 9, wherein a first photon flux of the first wavelength is 10¹¹ times greater than a second photon flux of the second wavelength.

14. The optical filter of claim 9, wherein a blocking level of the optical filter is at least optical density 10 (OD 10) level blocking at the first wavelength.

15. The optical filter of claim 9, wherein a blocking level of the optical filter is at least optical density 13 (OD 13) level blocking at the first wavelength.

16. The optical filter of claim 9, wherein the set of anti-reflectance coatings includes a multi-layer anti-reflectance coating with alternating layers of a first material with a first refractive index and a second material with a second refractive index.

17. An optical system, comprising:
a laser configured to output a beam associated with a first wavelength;
a set of optics configured to convert the beam associated with the first wavelength into a set of entangled signal photons associated with a second wavelength,
wherein the second wavelength is twice the first wavelength; and
a rejection filter configured to pass through the set of entangled signal photons associated with the second wavelength and block a residual pump portion of the beam associated with the first wavelength.

18. The optical system of claim 17, further comprising:
a detector configured to receive the set of entangled signal photons.

19. The optical system of claim 18, wherein the rejection filter is configured to achieve a ratio of signal photons to residual pump photons at the detector is at least (1×10⁻⁵):1.

20. The optical system of claim 17, wherein the set of optics includes a non-linear crystal associated with achieving spontaneous parametric down-conversion of the beam at the first wavelength to generate the set of entangled signal photons associated with the second wavelength.
